(19) United States
(12) Patent Application Publication
(10) Pub. No.: US 2006/0171159 A1
(43) Pub. Date: Aug. 3, 2006

(54) Rear light, particularly a stop light for a motor vehicle

(76) Inventor: Daniel Anderlini, Valdahon (FR)

Correspondence Address: Gary M Cohen;Strafford Building Number Three, Suite 300, 125 Strafford Avenue, Wayne, PA, 19087-3318, US

(21) Appl. No.: 10/549,159

(22) PCT Filed: Apr. 2, 2004
(86) PCT No.: PCT/FR04/00829

§ 371 Date: Sep. 14, 2005

(30) Foreign Application Priority Data
Apr. 4, 2003 (FR) 03/04173

(51) Int. Cl. F21V 9/00

(52) U.S. Cl. 362/511

(57) ABSTRACT

The present invention relates to a tail light, particularly a brake light for a motor vehicle, characterized in that it comprises at least one primary light source (2; 2′) consisting of at least one light-emitting diode (3; 3′) associated with a light guide (4; 4′) the shape of which is made up overall of a straight section and comprises an input surface (5), an output surface (6) forming a straight illuminating strip and, between the input surface (5) and the output surface (6), a beam-bending surface (7) allowing the input (5) and output (6) surfaces to be arranged in parallel planes.

The present invention relates to a tail light, particularly a brake light for a motor vehicle.

It relates more particularly to the production of a high-level third brake light arranged in the rear central part of a vehicle.

Such a brake light is generally made up of a multitude of light-emitting diodes (LEDs) mounted on a printed circuit board and arranged behind a transparent cover which alone is visible from outside the vehicle.

Arranging a multitude of LEDs, mounted in series on a printed circuit board, entails a board of a very large size. It proves to be the case that, in such brake lights, the printed circuit board is subjected to moisture so protection is required by covering the board with a protective layer. This coating, together with the high number of light-emitting diodes and the size of the printed circuit board, lead to costs which are not inconsiderable.

One of the objects of the present invention is to propose to reduce the cost of manufacture of such a brake light by reducing the number of LEDs while at the same time maintaining the same light output.

To this end, the subject of the present invention is a tail light, particularly a brake light for a motor vehicle, characterized in that it comprises at least one primary light source consisting of at least one light-emitting diode associated with a light guide the shape of which is made up overall of a straight section and comprises an input surface, an output surface forming a straight illuminating strip and, between the input surface and the output surface, a beam-bending surface allowing the input and output surfaces to be arranged in parallel planes.

According to a number of beneficial provisions of the invention:
the input surface of the light guide is formed of the combination of two optical lenses;

respectively a first lens said to be a refractive lens, inserted in an input cone for the rays of light originating from the primary light source allowing these rays of light to be reorientated into a parallel beam, and a second lens said to be a reflective lens, arranged coaxially in the same plane as the first lens and allowing the reorientation, such that they are parallel, of the beams of light that do not pass through the first lens and those that are reflected off the surface of the first lens;
the light output surface is made up of a plurality of reflective facets and the reflective facets are arranged at a pitch that defines the spacing of the illuminated zones and have a respective height that increases as a function of the remoteness of the facet from the light source;
the beam-bending surface is made up of an internal reflection lens arranged in such a way as to redirect the light beam towards the output surface;
the beam-bending surface is equipped with light output facets;
the light guide is made as a solid and transparent monolithic entity, preferably of plastic.

According to one particular embodiment, the brake light is made up of two primary light sources each made up of a pair of LEDs grouped together onto a printed circuit board installed at the centre of the brake light and of two light guides, respectively a left guide and a right guide which are associated with a primary source and of a transparent cover provided with striations or beads determining the angle at which the light is scattered.

The abovementioned characteristics of the invention, together with others, will become more clearly apparent when reading the following description of an exemplary embodiment, with reference to the attached drawings in which:

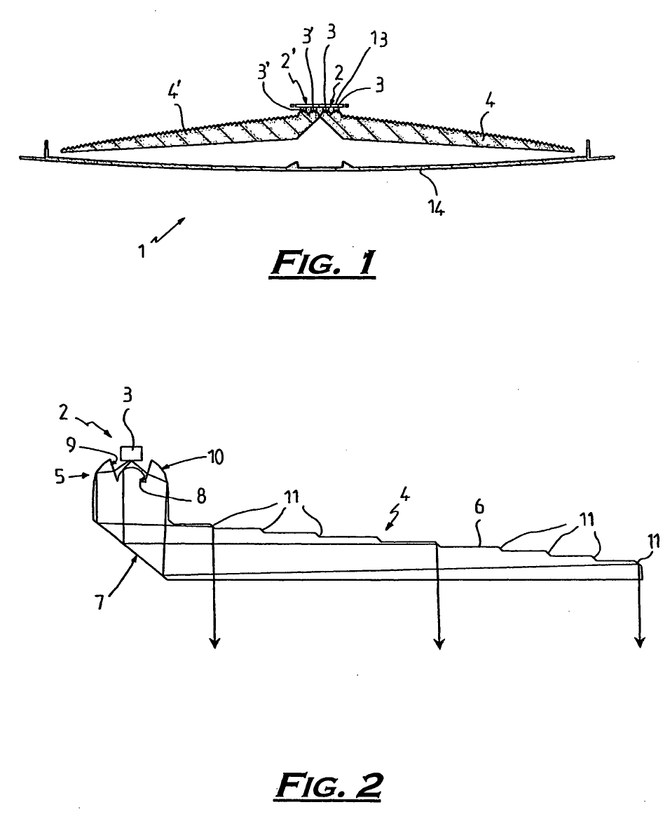

FIG. 1 is a schematic view in axial section of a brake light produced in accordance with the teachings of the invention;

FIG. 2 is a schematic view on a larger scale of the principle of operation of a brake light according to the invention;

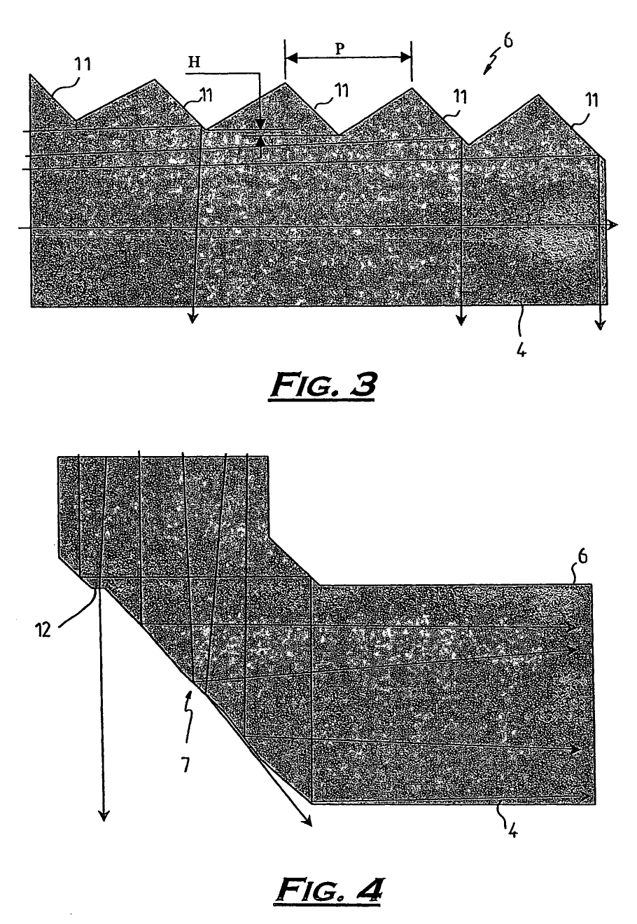

FIG. 3 is a schematic view on a larger scale of the output surface of the light guide according to FIG. 2; and

FIG. 4 is a schematic view on a larger scale of the beam-bending surface of the light guide.

FIG. 2 depicts a tail light, particularly a high-level brake light 1 for a motor vehicle.

According to the present invention, this brake light 1 comprises at least one primary light source 2 consisting of at least one light-emitting diode 3 associated with a light guide 4 the shape of which is made up overall of a straight section and comprises an input surface 5, an output surface 6 forming a straight illuminating strip and, between the input surface 5 and the output surface 6, a beam-bending surface 7 allowing the input 5 and output 6 surfaces to be arranged in parallel planes.

It should be noted that the light guide 4 is a solid and transparent monolithic entity, for example of plastic.

As can be seen in FIG. 2, the input surface 3 of the light guide advantageously is formed of the combination of two optical lenses; respectively a first lens 8 said to be a refractive lens, inserted in an input cone 9 for the rays of light originating from the primary light source 2 allowing these rays of light to be reorientated into a parallel beam, and a second lens 10 said to be a reflective lens, arranged coaxially in the same plane as the first lens 8 and allowing the reorientation, such that they are parallel, of the beams of light that do not pass through the first lens 8 and those that are reflected off the surface of the first lens thus offering optimal recovery of the light beam.

It will be noted that the angle of the input cone 9 is configured in such a way as to ensure adequate mould release of the waveguide 4.

The entire reorientated light beam originating from the input 5 of the light guide 4 is directed in an almost perpendicular direction towards the output surface 6 by the beam-bending surface 7 that forms an internal reflection lens.

This light output surface 6 is made up of a plurality of reflection facets 11, the number of which is designed to direct the light as demanded by the characteristics of the brake light.

In order for the lighting strip to maintain a uniform light intensity along its entire surface, the reflection facets 11 are arranged at a pitch P defining the spacing of the illuminated zones and have a respective height H which will influence the amount of light reaching the facet 11. Note that this height H of a facet 11 increases as a function of the remoteness of the facet 11 from the source, as can be seen in FIG. 3.

Furthermore, in order to avoid creating a zone that is dark by comparison with the rest of the brake light in the region of the beam-bending surface 7, which allows only very few rays to escape, light output facets 12 are advantageously arranged on this beam-bending surface 7 as can be seen in FIG. 4. The number of output facets 12 depends on the pitch P of the reflection facets 11 so as to maintain a uniform light intensity.

According to one particular embodiment of the present invention, which embodiment is depicted in FIG. 2 without implying any limitation, the brake light 1 is made up of two primary light sources 2, 2′ each made up of a pair of LEDs 3, 3′ grouped together onto a printed circuit board 13 installed at the centre of the brake light 1 and of two light guides, respectively a left guide 4′ and a right guide 4 which are associated with a primary source 2′ and 2 and of a transparent cover 14 provided, in the conventional way, with striations or beads (not visible) determining the angle at which the light is scattered.

It may be advantageous to arrange on the transparent cover 14 facets that make it possible to recover some of the rays that escape from the beam-bending surface 7.

As can be seen in this FIG. 2, the diodes 3, 3′ of one and the same primary light source 2, 2′ are, according to this embodiment, arranged at the input to the waveguide 4 along its length. However, according to an alternative form of embodiment it will be understood that it is possible to arrange the diodes of one and the same primary light source along the width of the input surface without altering the operating principle, only the external appearance will be changed as a result of doing this.

It will be understood from reading the above description that the brake light of the present invention is relatively simple to produce and affords a production saving by comparison with the solutions of the state of the art by limiting the number of diodes used and therefore the size of the printed circuit board. Furthermore, such a brake light offers the advantage of consuming less energy and proves to be more reliable than the solutions of the prior art.

Although the invention has been described in conjunction with one particular embodiment, it encompasses all technical equivalents of the means described.

1-6. (canceled)

7. A tail light useful as a brake light for a motor vehicle, comprising:
at least one primary light source including at least one light-emitting diode associated with a light guide;
wherein the light guide has an overall shape defined by a straight section, and wherein the light guide includes an input surface, an output surface which forms a straight illuminating strip, and a beam-bending surface between the input surface and the output surface for allowing the input surface and the output surface to be arranged in parallel planes, wherein the input surface of the light guide is formed of a combination of two optical lenses including;
a first lens, wherein the first lens is located in an input cone, and wherein the first lens has a surface which is shaped to reorient rays of light originating from the primary light source into a parallel beam; and
a second lens, wherein the second lens is arranged coaxially with and in the same plane as the first lens, and wherein the second lens operates to reorient rays of light that do not pass through the first lens and rays of light that are reflected off the surface of the first lens so that the rays of light are parallel with one another.

8. The tail light of claim 7 wherein the first lens is a refractive lens.

9. The tail light of claim 7 wherein the second lens is a reflective lens.

10. The tail light of claim 7 wherein the output surface includes a plurality of reflective facets.

11. The tail light of claim 10 wherein the reflective facets are arranged at a pitch (P) for defining spacings between a plurality of illuminated zones, and at heights (H) that increase as a function of remoteness of a facet from the primary light source.

12. The tail light of claim 7 wherein the beam-bending surface is an internally disposed, reflective lens positioned to redirect the parallel beam toward the output surface.

13. The tail light of claim 12 wherein the beam-bending surface further includes light output facets.

14. The tail light of claim 7 wherein the light guide is formed as a solid and transparent unitary structure.

15. The tail light of claim 14 wherein the light guide is formed of a plastic.

16. A brake light which comprises the tail light of claim 7, and which further includes:
two primary light sources, wherein each of the two primary light sources is a light-emitting diode, and
wherein the two light-emitting diodes are grouped together onto a printed circuit board;
wherein the brake light and the printed circuit board each have a center, and wherein the center of the printed circuit board is positioned at the center of the brake light and two light guides associated with the brake light; and
wherein a left light guide is associated with one of the two primary light sources, and a right light guide is associated with another of the two primary light sources; and
a transparent cover having surface features for determining an angle at which light is scattered.

17. The brake light of claim 16 wherein the surface features are striations.

18. The brake light of claim 16 wherein the surface features are beads.
